(19) United States
(12) Patent Application Publication
(10) Pub. No.: US 2026/0227758 A1
(43) Pub. Date: Aug. 6, 2026

(54) Method for Monitoring a Production Process, Computer Program, and Electronically Readable Data Carrier

(71) Applicant: Bayerische Motoren Werke Aktiengesellschaft, Muenchen (DE)

(72) Inventors: Ingo HEINLE, Inzell (DE); Tom Janis KRAUSE, Muenchen (DE); Christian SCHELSKE, Marklkofen (DE)

(21) Appl. No.: 19/149,630

(22) PCT Filed: Mar. 8, 2024
(86) PCT No.: PCT/EP2024/056144

§ 371 Date: Jul. 21, 2025

(30) Foreign Application Priority Data
Mar. 30, 2023 (DE) 10 2023 108 181.0

(51) Int. Cl. G05B 19/4063

(52) U.S. Cl. CPC G05B 19/4063; G05B 2219/31455

(57) ABSTRACT

A method for monitoring a production process incudes ascertaining a first respective similarity and a second respective similarity. The method also includes selecting at least one inventory data record if the associated first similarity lies within a first tolerance value and the second similarity lies within a second tolerance value. The method also includes forming a respective difference between the structural-member quality of the at least one selected inventory data record and the structural-member quality of the current data record. The method also includes outputting a signal as a function of a magnitude of the difference.

### BACKGROUND AND SUMMARY

The disclosure relates to a method for monitoring a production process in which a structural member having a structural-member quality is produced from a semifinished product by using at least one process parameter, according to this specification. The disclosure further relates to a computer program and also to an electronically readable data carrier.

A structural member, such as a structural member of a vehicle body for instance, is produced or manufactured, as a rule, by means of a production process which is carried out, for instance, by means of a production plant such as a press shop. Accordingly, the manufacturing of structural members of vehicle bodies in press shops can, for instance, be broken down into several process steps which together can describe the production process. Firstly, sheet-metal blanks are cut out of a coil in a coil plant. In this process, traceable stacks of blanks, or semifinished products, which, as a rule, are stored temporarily prior to processing, can be created. The press shop may include a press line in which, as a rule, deep drawing of the cut blank, or of the semifinished product, which may be a flat sheet, is undertaken. Subsequently, trimming and/or postforming, for instance, can be undertaken in further process steps.

The processed sheets, in particular thin sheets, or semifinished products, exhibit, as a rule, fluctuations with respect to their properties. For instance, the sheet thickness, the tribological properties such as a quantity of lubricant, the roughness, and also elastoplastic material properties may turn out to be variable from semifinished product to semifinished product. Depending upon the precise expression of such a fluctuation, it may be necessary to adapt at least one process parameter that is being used in the production process and that describes, for instance, a state or a property of an apparatus, such as, for instance, a tool in the press line. Accordingly, a demanded quality of the structural member to be manufactured or produced can be achieved through the adaptation of the at least one process parameter. Changes in the production process may, furthermore, result in a necessity to adapt process parameters. Changes can, for instance, be made to a press, to the tools, and also to the transport systems for transfer between stations within a press line. Furthermore, changes to blank-cutting plants and/or in logistical processes may also result in a change in the production process that makes an adaptation of the process parameters necessary.

For instance, in a continuous production process in the automotive industry or, to be more precise, in coachbuilding, drawbeads are reworked at regular intervals, due to wear. As a result of such a reworking in respect of the tool, considerable changes in the retaining forces generated by the drawbead may occur, and consequently an adaptation of process parameters may be required. As a rule, the adaptation of the process parameters that are associated with a downtime of the plant is undertaken by a plant operator on the basis of experience. By reason of a loss of production as a result of the downtime, an adaptation of the process parameters is consequently associated with a loss of production and therefore with costs.

Die-cushion forces, setting of one or more drawing aids, establishment of a position of one or more guides, kinematics of a ram motion and/or an application of additional lubricant may represent examples of a process parameter. Furthermore, a setting of a straightener in the coil plant can also be adjusted via a process parameter.

Currently, semifinished-product properties, indirect and direct data relating to the quality of the structural member and to the associated intermediate products, as well as process parameters of the coil plant and of the press line, can be recorded and allocated to a blank, or to a semifinished product, and also to a structural member. This allocation is undertaken, for instance, via a serial number that is applied to the surface of the material during the cutting of the blank. These data can be made available in a database and can be used, for instance, by assistance systems that are able to propose process parameters by means of an algorithm.

The object of the present disclosure is to provide a method, a computer program and also a data carrier for advantageous monitoring, and consequently controlling, of a production process or production processes, by means of which a structural member is produced in each instance.

In accordance with the disclosure, this object is achieved by virtue of the subjects of the independent claims. Advantageous configurations and developments of the disclosure are specified in the dependent claims and also in the description and in the drawing.

A first aspect of the disclosure relates to a method for monitoring, in particular, at least one production process in which a structural member having a structural-member quality is produced from a semifinished product exhibiting at least one semifinished-product property by using at least one process parameter that characterizes a state and/or a property of an apparatus being used for the production process, for instance a production plant such as a press or a press line.

The at least one process parameter may, in particular, comprise or describe parameters that are capable of being changed in respect of tools, in respect of transport systems and also in respect of presses, in order to influence the quality of the structural member manufactured-that is to say, the structural-member quality. The apparatus comprises, for instance, a tool, a press or such like, and may, in particular, take the form of a production plant. The semifinished product describes a preliminary stage of the structural member and is formed or processed into the structural member by means of the production process which, for instance, may comprise several production steps. In each production process, in particular a structural member is created or produced from a semifinished product.

In order now to monitor the production process by means of the method according to the disclosure, this method comprises the following steps:

In the first step, inventory data records are made available, an inventory data record being made available in each instance for a production process already carried out, this inventory data record comprising the structural-member quality of the structural member produced in the course of the production process carried out, the at least one process parameter used and/or the at least one semifinished-product property. The respective inventory data record consequently comprises the at least one semifinished-product property of the semifinished product from which the structural member was produced in the course of the production process carried out and the at least one process parameter used in this process for or by the apparatus.

In the second step, a current data record is created that comprises the at least one semifinished-product property of the semifinished product being used in the current production process, the at least one current process parameter and/or the associated structural-member quality. The current data record consequently comprises information such as semifinished-product property and/or process parameters and/or associated structural-member quality of a structural member created, in particular, last or at least after the respective production process of the respective inventory data record.

In a third step, a first respective similarity between the at least one process parameter of the respective inventory data record and the at least one process parameter of the current data record is ascertained. In the course of the ascertainment, in particular a comparison between respective process parameters of the inventory data records and the process parameter, corresponding thereto, of the current data record can consequently be undertaken.

In the fourth step, a second respective similarity between the at least one semifinished-product property of the respective inventory data record and the at least one semifinished-product property of the current data record is ascertained. In the course of the ascertainment, in particular at least one comparison of the at least one current semifinished-product property with the respective semifinished-product property of the respective inventory data record of the inventory data records can consequently be undertaken.

In the fifth step, at least one inventory data record is selected if the associated first similarity lies within a first tolerance value and the associated second similarity lies within a second tolerance value. The respective tolerance value may, for instance, describe or characterize an inaccuracy of measurement when capturing the at least one process parameter or the at least one semifinished-product property.

In the sixth step, a respective difference between the structural-member quality of the at least one selected inventory data record or inventory data records and the structural-member quality of the current data record is formed.

Finally, in a seventh step, a signal is output as a function of a magnitude of the difference formed.

The difference or, to be more precise, its magnitude is a measurement for detecting indications for interventions in the production of the structural member, caused by changes in production processes. The signal may, for instance, comprise an electrical signal of a control device and/or an optical signal of an output device and may, for instance, indicate at least the result of the difference. Should the difference exceed a threshold value that, for instance, corresponds to a third tolerance value and characterizes, for instance, an inaccuracy of measurement, and consequently is strongly suggestive of a change in the structural-member quality, the signal can be adapted accordingly.

The insight underlying the disclosure is that changes in production processes for the purpose of adapting process parameters may be necessary for obtaining a structural-member quality. It cannot generally be assumed that a plant operator and/or an algorithm for recommending process parameters will be informed of a change carried out in respect of the respective production process. If, after such a change, the quality of the structural members produced does not satisfy the desired requirements, the finding of the cause constitutes a challenge. In principle, non-compliance with quality requirements may be caused both by fluctuating semifinished-product properties and/or by intentional as well as unintentional changes in the production process.

Changes in a production process can, to the extent that they are not known, only be detected during operation or, to be more precise, during the implementation of the production process. In such a situation it may be necessary, for instance under great time-pressure, for new suitable process-parameter combinations to be found so that a production order, which, for instance, may comprise several production processes, can be processed successfully. In this connection, downtimes and/or costs may arise. Furthermore, algorithms, when these are employed in order to predict the at least one process parameter, may fail if, for instance, the mechanical behavior of the production process has changed significantly as a result of changes in the production process in comparison with the previous state.

An early ascertainment of the causes of the changes in the production process may considerably accelerate a remedying of the problem. It is an advantage to recognize as promptly as possible to what extent non-compliance with the quality requirements is to be ascribed to fluctuations in the semifinished-product properties and/or to intentional as well as unintentional changes in the production process. Furthermore, this information can be used for the purpose of adapting algorithms to the changed production process. Precisely this can be obtained by means of the method according to the disclosure. Accordingly, the method according to the disclosure is employed, in particular, if structural members produced do not satisfy a demanded quality requirement.

In other words, data from the production process currently running are compared in the course of the method with records of production processes carried out earlier. In this connection, a material is sought that in terms of its property resembles as closely as possible the material that is presently awaiting processing, and, in particular, the same or a particularly similar at least one process parameter was employed for the processing, this process parameter having been set currently in the production plant or in the apparatus. If a data record can be found in this way and it is evident therefrom that the quality of the structural members produced differs significantly between the state that was recorded in the past and the production process currently running, this is an indication of a change in the production process. By virtue of the method according to the disclosure, the advantage arises that a rapid and/or simple detecting of changes in the production process is made possible. Furthermore, another advantage is a particularly rapid identification of sources of error.

In an advantageous configuration of the disclosure, the at least one semifinished-product property of the semifinished product being used in the current production process, the at least one current process parameter and/or the associated structural-member quality are captured by at least one sensor device, and/or the at least one process parameter is adapted or at least proposed for a following production process as a function of the signal and consequently of the magnitude of the difference. In other words, at least one sensor device has been provided which has been designed to capture or to determine the at least one semifinished-product property of the semifinished product in terms of at least one process parameter and/or the associated structural-member quality of the structural member created by means of the process parameter and the semifinished product. Additionally or alternatively, the at least one process parameter is adapted as a function of the signal that can be output or adapted as a function of the magnitude of the difference. This means that the at least one process parameter is proposed, for instance by an algorithm, in particular a self-learning algorithm, and this process parameter is set, for instance on the apparatus. As a result, the advantage arises that the method can be used particularly advantageously for the purpose of producing the structural member, in that by virtue of the method the choice of the at least one process parameter can be made, and the structural member can be produced with the chosen at least one process parameter. A further advantage is that through the use of the at least one sensor device the current data record can be created particularly advantageously.

In another advantageous configuration, a check is made, in particular, for instance, prior to the implementation of the first step, as to whether a deviation of the structural-member quality of the structural member currently being produced from a demanded structural-member quality obtains, and as to whether this deviation lies above a threshold value. In other words, a check is made as to whether a demanded structural-member quality—for instance, a size of the formed part or a deviation between an actual geometry and a target geometry—is being adhered to by the current production process, or as to whether this deviation lies above a threshold value which, in particular, for instance, may have been predetermined. If the deviation lies within the threshold value, the signal can, for instance, be output directly without carrying out any further processing steps. If this deviation lies above the threshold value, this can initiate the method. As a result, the advantage arises that the production process and the operating of the apparatus can be carried out particularly efficiently.

In another advantageous configuration of the disclosure, the inventory data record and/or the current data record is/are each created from a first tuple that comprises the at least one associated semifinished-product property, from a second tuple that comprises the at least one associated process parameter, and/or from a third tuple that comprises the associated structural-member quality. In other words, for the respective data record—that is to say, the current data record and also the inventory data record—the at least one semifinished-product property, in particular several semifinished-product properties, of the associated structural member are consolidated into a first tuple. In analogous manner, the respective at least one process parameter, in particular several process parameters, is/are consolidated into a second tuple. The structural-member quality, or values that characterize or describe the structural-member quality, for instance a shape and/or a surface condition of the structural member, can be consolidated into a further tuple. The respective tuple is, in particular, a list of semifinished-product properties, process parameters, or values that characterize the structural-member quality. The respective data record-that is to say, the current data record or the at least one inventory data record-can consequently be created in each instance from one to three tuples. As a result, the advantage arises that the method can be carried out in particularly efficient manner.

Accordingly, in another advantageous configuration of the disclosure the respective tuple describes a respective vector, or the respective tuple predetermines a respective vector. Additionally or alternatively, a structural-member ID of the underlying structural member or semifinished product is assigned to the respective tuple. In other words, the respective tuple constitutes a respective vector. Additionally or alternatively, a structural-member ID-which may be represented, in particular, by a serial number of the structural member-can be added as a value, or index, to the respective tuple or vector. As a result, the advantage arises that, for instance, the first and/or the second similarity, or the difference, can be ascertained in particularly advantageous manner. Furthermore, an electronic computing device, for instance, by which the method can be carried out at least partly, may have been optimized particularly advantageously for a vector calculation, so that the method can be carried out particularly efficiently.

In another advantageous configuration of the disclosure, the first similarity and/or the second similarity and/or the difference is/are constituted by at least one magnitude of a difference vector which is created from the respectively corresponding vector of the selected inventory data record and from the respectively corresponding vector of the current data record. In other words, the respective inventory data record, or the current data record, comprises, for instance, a vector that describes the at least one semifinished-product property, a vector that describes the at least one process parameter, and/or a vector that describes the at least one structural-member quality. These vectors can each be created from the respective tuple. Accordingly, a vector of the inventory data record that describes at least one semifinished-product property, and a vector of the current data record that describes the at least one semifinished-product property, may now obtain. These vectors can, for instance, be subtracted from one another in order to create a difference vector. A magnitude of the difference vector, or a respective magnitude of the individual components of the difference vector, can now be created which can be used, for instance, for the second similarity. A procedure can be followed in analogous manner for the first similarity and the difference. As a result, the advantage arises that the method can be carried out particularly efficiently, since, for instance, recourse may be had to an efficient vector calculation.

In another advantageous configuration of the disclosure, at least two inventory data records are selected, and these records are combined to form a consolidated inventory data record, for instance by averaging. In this connection, the consolidating can be carried out for a respective tuple of the tuples contained in the at least two inventory data records, or for a respective vector of the vectors contained in the at least two inventory data records. The method steps in which the inventory data record is used—that is to say, in particular, method steps S3 to S7—can then be carried out with the corresponding consolidated inventory data record instead of with the individual inventory data record. As a result, the advantage arises that, for instance, fluctuations of the individual production processes carried out previously can be compensated, as a result of which the method can serve particularly advantageously as an indication for interventions in the production process.

In another advantageous configuration of the disclosure, for several structural members a current data record is created in each instance, and from at least two of the current data records a consolidated data record is created as a function of the respective at least one semifinished-product property and/or of the respective at least one process parameter and/or of the respective structural-member quality. In particular, the method, or the steps that require using the current data record, is/are carried out with the consolidated data record-that is to say, the current data record is replaced by the consolidated current data record. In other words, a current data record is created from several current data records, particularly if, for instance, the semifinished-product properties thereof (that is to say, of the individual data records) are the same within the tolerance value or within an accuracy of measurement, by virtue of which the functional relationship may have been given. Additionally or alternatively, this can be undertaken not only as a function of the semifinished-product properties but also as a function of the at least one process parameter or of the structural-member quality. As a result, the advantage arises that fluctuations of the production processes can be compensated in particularly advantageous manner, so that a change in production processes can be ascertained in advantageous manner.

A second aspect of the disclosure comprises a computer program. The computer program can, for instance, be loaded in a memory of the electronic computing device, in particular of a production plant that carries out the production process, and comprises program means in order to execute the steps of the method when the computer program is executed in the electronic computing device or in a control device.

Advantages and advantageous configurations of the first aspect of the disclosure are to be regarded as advantages and advantageous configurations of the second aspect of the disclosure, and conversely.

A third aspect of the disclosure relates to an electronically readable data carrier.

The electronically readable data carrier includes electronically readable control information stored thereon that comprises at least one computer program as just presented and that has been configured in such a manner that it can execute a method presented herein according to the first aspect of the disclosure when the data carrier is used in an electronic computing device.

Advantages and advantageous configurations of the third aspect of the disclosure are to be regarded as advantages and advantageous configurations both of the second and of the first aspect of the disclosure, and conversely in each instance.

Further features of the disclosure arise out of the claims, the Figures and the description of the Figures. The features and combinations of features mentioned above in the description, and also the features and combinations of features mentioned below in the description of the Figures and/or shown in the Figures alone, are capable of being used not only in the combination specified in the given case but also in other combinations or on their own.

The disclosure will now be elucidated in more detail with the aid of a preferred embodiment and also with reference to the drawing, in which:

### BRIEF DESCRIPTION OF THE DRAWING

FIG. 1 shows a schematic flowchart of a method for monitoring a production process in which a structural member is produced from a semifinished product by using at least one process parameter.

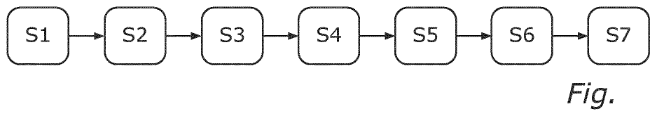

### DETAILED DESCRIPTION OF THE DRAWING

The single FIGURE, Fig., shows a schematic flowchart for a method for monitoring a production process in which a structural member having a structural-member property is produced from a semifinished product exhibiting at least one semifinished-product property by using at least one process parameter that characterizes a state and/or a property of an apparatus being used for the production process.

The method comprises at least steps S1 to S7:

In the first step S1, inventory data records are made available, an inventory data record being made available in each instance for a production process already carried out, this data record comprising the structural-member quality of the structural member produced in the course of the production process carried out, the at least one process parameter used and/or the at least one associated semifinished-product property. In the second step S2, a current data record is created that comprises the at least one semifinished-product property of the semifinished product being used in a current production process, the at least one current process parameter and/or the associated structural-member quality. In the third step S3, a first respective similarity between the at least one process parameter of the respective inventory data record and the at least one process parameter of the current data record is ascertained. In the fourth step S4, a second respective similarity between the at least one semifinished-product property of the respective inventory data record and the at least one semifinished-product property of the current data record is ascertained. In the fifth step S5, at least one inventory data record is selected if the associated first functional relationship lies within a first tolerance value and the second similarity lies within a second tolerance value or tolerance range. In the sixth step S6, a respective difference between the structural-member quality of the at least one selected inventory data record and the structural-member quality of the current data record is formed. In the seventh step S7, a signal is output that can describe, in particular, a result of the subtraction, and/or a warning is output as a function of a magnitude of the difference formed.

In the following, an exemplary method sequence will be described. The method can be used, in particular, to operate an apparatus that, in particular, may comprise a production plant or may have been formed as one, such as, for instance, a press of a press line, and to control the production process forming a structural member in each instance in such a manner that a desired structural-member quality is obtained.

The method further serves to ascertain or to establish, in particular, unknown changes in the production process or, to be more precise, the influence of such changes on process parameters and/or on the structural-member quality, and, in addition to this, to be able to output an appropriate warning by means of the signal. In this process, data from the production process currently running are compared, with the aid of the current data record, with records of production processes carried out earlier—the inventory data records—in the course of which data, or information relating to data, are to be found, or data-pairs are created that exhibit properties as similar as possible both in the case of the at least one semifinished-product property and in the case of the at least one process parameter. This means that at least one inventory data record is ascertained that matches the current data record in terms of its structural-member quality and/or semifinished-product property, as a result of which a check can be made as to whether changes are occurring to the quality of the structural member being produced. If this is the case, this may be an indication of a change in the production process.

The ascertaining, or determining, of the similarities can be carried out, for instance, in such a manner that data with respect to the at least one semifinished-product property or with respect to the semifinished-product properties of a structural member are consolidated into a vector H for the purpose of evaluating the second similarity.

It is an advantage if both the inventory data record and the current data record are created from a first tuple that comprises the at least one associated semifinished-product property, from a second tuple that comprises the at least one associated process parameter, and/or from a third tuple that comprises the at least one associated structural-member quality, it being an advantage, furthermore, if the respective tuple describes a respective vector such as, for instance, vector H. Advantageously, all the structural members are assigned—for instance, in the form of a serial number—to the respective vector and to the respective data record—that is to say, to the inventory data record and also to the current data record.

The at least one—in particular, measured—semifinished-product property, in which connection, in particular, several semifinished-product properties obtain for a respective semifinished product, may be considered as a component of vector H. It is furthermore an advantage if, for the determining of the at least one semifinished-product property and/or of the at least one current process parameter and/or of the associated structural-member quality, in particular relating to the current production process, at least one sensor device is made available, by means of which a respective measurement having, in particular, a known error value or a known inaccuracy of measurement, which can be used as a tolerance value, can be carried out.

A semifinished-product property might be, for instance, a sheet thickness. All the values captured, in particular, by the at least one sensor device-that is to say, measured values-relate to the respective structural member that was manufactured with the respective properties of the associated inventory data record or current data record. For the purpose of evaluating the first similarity, which relates to the at least one process parameter and in particular to several process parameters, a procedure is followed in analogous manner, wherein these parameters can be consolidated into a vector P for the respective structural member, wherein each component of the vector represents or describes the value of one of the at least one process parameters and consequently, in particular, of the several process parameters. Finally, the recorded or measured structural-member quality of the respective structural member can be reproduced in a vector Q. As in the case of vectors H and P, each component of vector Q may comprise a captured measured value. Vectors Q and H can finally be consolidated into a vector QH that contains or comprises for a respective structural member the at least one semifinished-product property or, in particular, the several semifinished-product properties and also the captured quality of the structural member.

The first tolerance value and the second tolerance value which are used in the method, and also the magnitude of the difference, may be specified, for instance, by a tolerance specification or by an error for the respective measurement carried out, in particular, by means of the sensor device. Accordingly, the tolerance may comprise a lower limit and an upper limit. The tolerance consequently includes the inaccuracy of measurement of the at least one sensor. This tolerance can furthermore be enlarged additively and/or multiplicatively. The tolerance values created from the respective tolerance can be created for the semifinished-product properties, for the measurement data with respect to the measurement of the quality of the structural members, and for sensor values that describe the process parameters. The tolerance of the at least one process parameter may, for instance, be rounding-errors in the course of data processing by the apparatus, or deviations between the set value and the actual value.

Prefixes and also a respective index may be introduced for the vectors, in order, for instance, to identify whether it is a question of an inventory data record or the current data record of a structural member currently being produced. Accordingly, prefix a can be used for current structural members, and prefix v can be used for structural members produced in the past. The vectors are supplemented additionally by an index that is constituted by a structural-member ID. This structural-member ID may correspond to a serial number of the structural member being manufactured in the given case, and in the following will be placed after the designation of the vector.

In the following, it will be assumed that the serial number is a sequential number, so that in the case of the first structural member this number has the value 1, and in the case of the second structural member the value 2, and so on. Consequently, the serial number has the value u after u structural members have been produced. For instance, in the case of vector vHi it is a question of a structural member that has serial number i and was produced in the past, and consequently vector H characterizes or constitutes, at least partly, the associated inventory data record.

In the following, the structural member currently being produced will bear the designation “structural-member ID k”, and a structural member that was produced in the past will bear “structural-member ID i”. Here, it holds that i<k. Advantageously, structural member i may stem from a preceding production order, so that changes in the manufacturing process or production process that occurred between the last production process and the current production process or manufacturing process can be detected.

Accordingly, in particular for steps S3 and S4, for instance, a vector vHi is sought for which, in particular, vPi=aPk holds, or vPi and aPk differ only within a predetermined tolerance. Accordingly, a structural member is sought that was produced in the past and was processed with the same at least one process parameter—in particular, with several process parameters—as structural member k currently being produced. In addition, the structural member being sought is to have a vector vHi similar to that of the current structural member (aHk).

For the purpose of evaluating or ascertaining the similarity of vectors vHi and aHk, a calculation of the absolute value of the differences of the individual components can be carried out. In this connection, a respective vector component dhik=|vHi−aHk| of a vector dHva (d: difference) can be created. In other words, it is an advantage if the first similarity and/or the second similarity and/or the difference is/are constituted by at least one magnitude of a difference vector that is created from the vector of the selected inventory data record and the vector of the current data record. To the extent that each component dhik of vector dHva is less than or equal to the tolerance of the individual measured values of the semifinished-product properties, vectors vHi and aHk are considered to be equal or especially similar. If a vector vHi satisfies this condition, a structural member i has been found that was manufactured with at least one semifinished-product property or with several semifinished-product properties similar to that/those of structural member k.

Subsequent to this, the difference dQva of each individual one of vectors vQi and aQk is determined. The difference is, likewise, advantageously a vector. If a difference of an individual component from dQva results that is greater than the tolerance that was determined above—that is to say, the magnitude of the difference, or of the individual values of the measurements, with regard to the structural-member quality exceeds the tolerance—this is an indication of the occurrence of a change in the production process.

In order to avoid significant effects resulting from artifacts of individual measurements, the evaluation may, as shown hitherto, be undertaken not only with respect to two structural members i and k, but rather it is recommended to use several structural members for the purpose of representing the current production and the past production.

Accordingly, at least two inventory data records should furthermore be advantageously selected, and these records should be combined to form a consolidated inventory data record, and the method should be carried out with the consolidated inventory data. Furthermore, it is an advantage to create, in each instance, a current data record for several structural members, and to create a composite current data record from at least two of the current data records, in particular as a function of the at least one semifinished-product property and/or of the at least one process parameter and/or of the structural-member quality.

The inventory data records of past production runs do not have to stem from a single manufacturing process but may stem from different manufacturing processes, in which case the respective manufacturing process or manufacturing order may comprise several production processes. Now in order accordingly to avoid the artifacts of the measurements, several vectors aQH are consolidated into a set of vectors aQH^{m}={aQHk, aQHk−1, aQHk−2, . . . , aQHk−n}. The superscript m stands for a set. For instance, with n=10 it may be a question of 10 vectors. For all aQHk of set aHI^{m}, identical process parameters aP were used for the purpose of manufacturing the structural members. From these n=10 vectors, that representative vector aQHr which is contained in set aQH^{m} can be ascertained, the component of which exhibit the least difference from a vector aQH^{m}ₘ. Vector aQH^{m}ₘ is, in turn, ascertained by averaging the individual components aQH^{m}.

For instance, for the calculation of the average value of the second component of aQH^{m}ₘ, all the values of the second component of all the vectors aQH^{m} are formed. Alternatively, the use of the median is also conceivable. The representative vector aQHr consequently contains data with respect to the quality of the structural member and also of the associated at least one semifinished-product property of the semifinished product. The inclusion of the quality data of the structural member is undertaken, in particular, that artifacts may arise both in the course of the measurement of the at least one semifinished-product property and in connection with the quality of the structural members produced.

Vector aQH^{m}ₘ is not used as a representative vector, or as a reference, that does not reproduce the properties of a structural member produced. Furthermore, a second set vH^{m} is created of vectors that represent states from the past. In this connection, k vectors may be sought, the process parameters of which tally with the parameters aP and are similar to aQHr, or aHr. The calculation of similarity is undertaken in the manner outlined above, so that the first similarity and the second similarity can be ascertained analogously.

Subsequently the selection of a representative structural member vQHr can be undertaken. For the selection of the representative, the vectors of set vH^{m} are supplemented by the corresponding vectors of quality vQ. Set vQH^{m} can consequently be created. In conclusion, vector vQr and vector aQr can be extracted respectively from vectors vQHr and aQHr. In these cases, in particular the magnitude of the difference between the individual vector components can be formed. This results in vector dQva and the respective vector component dqva.

If the value of one of the vector components of dqva exceeds the tolerance, or the magnitude of the difference of the vector component exceeds a certain threshold value, this is an indication of a change within the production process, whereupon the signal according to step S7 of the method can be output. Depending on the signal, or on the type of signal, the adaptation of the at least one process parameter, or at least a proposal of the at least one process parameter, for instance by an algorithm, in particular a self-learning algorithm, of an electronic computing device, can now be undertaken.

In addition to the method that has been presented, a computer program that can execute the method steps when it is executed in the stated electronic computing device, and also an appropriate electronically readable data carrier storing the computer program, are to be presented. Advantages of the method and also of the computer program and of the data carrier are both a rapid and a simple detection of changes in production processes. Furthermore, by this means a particularly rapid identification of sources of error when operating the apparatus or when carrying out the production process can be ascertained. Consequently a method is feasible for detecting indications for interventions in the production of structural members, such as structural members of vehicle bodies for instance, caused by changes in production processes.

List of Reference Symbols

| | |
|---|---|
| S1 | first step |
| S2 | second step |
| S3 | third step |
| S4 | fourth step |
| S5 | fifth step |
| S6 | sixth step |
| S7 | seventh step |

1.-10. (canceled)

11. A method for monitoring a production process in which a structural member having a structural-member quality is produced from a semifinished product exhibiting at least one semifinished-product property by using at least one process parameter that characterizes a state and/or a property of an apparatus being used for the production process, the method comprising:
making inventory data records available, an inventory data record being made available for each production process already carried out, the inventory data records comprising structural-member quality of the structural member produced in the course of the production process carried out, the at least one process parameter used and/or the at least one semifinished-product property;
creating a current data record that comprises the at least one semifinished-product property of the semifinished product being used in the course of a current production process, the at least one current process parameter and/or the associated structural-member quality;
ascertaining a first respective similarity between the at least one process parameter of the respective inventory data record and the at least one process parameter of the current data record;
ascertaining a second respective similarity between the at least one semifinished-product property of the respective inventory data record and the at least one semifinished-product property of the current data record;
selecting at least one inventory data record if the associated first similarity lies within a first tolerance value and the second similarity lies within a second tolerance value;
forming a respective difference between the structural-member quality of the at least one selected inventory data record and the structural-member quality of the current data record; and
outputting a signal as a function of a magnitude of the difference.

12. The method according to claim 11, further comprising:
using the at least one semifinished-product property of the semifinished in the current production process, the at least one current process parameter and/or the associated structural-member quality is/are captured by at least one sensor device, and/or the at least one process parameter is adapted as a function of the signal for a following production process.

13. The method according to claim 11, wherein
a check whether a deviation of the current structural-member quality from a demanded structural-member quality lies above a threshold value.

14. The method according to claim 11, wherein
the inventory data record and/or the current data record is/are each created from a first tuple that comprises the at least one associated semifinished-product property, from a second tuple that comprises the at least one associated process parameter, and/or from a third tuple that comprises the associated structural-member quality.

15. The method according to claim 14, wherein
the respective tuple describes a respective vector, and/or a structural-member ID is assigned to the respective tuple.

16. The method according to claim 11, wherein
the first similarity and/or the second similarity and/or the difference is/are constituted by at least one magnitude of a difference vector that is created from the respectively corresponding vector of the selected inventory data record and the respectively corresponding vector of the current data record.

17. The method according to claim 11, further comprising:
selecting at least two inventory data records, and combining the at least two inventory data records to form a consolidated inventory data record.

18. The method according to claim 11, further comprising:
creating a current data record for several structural members, and creating a consolidated data record from at least two of the current data records as a function of the respective at least one semifinished-product property and/or of the respective at least one process parameter and/or of the respective structural-member quality.

19. A non-transitory computer readable storage program storing instructions, which when executed by a processor cause the processor to execute the method according to claim 11.
